(19) United States
(12) Patent Application Publication
(10) Pub. No.: US 2007/0249351 A1
(43) Pub. Date: Oct. 25, 2007

(54) Trasmitting/receiving apparatus and method in a mobile communication system

(75) Inventors: Eun-Jung An, Suwon-si (KR); Kang-Gyu Lee, Yongin-si (KR); Yun-Sang Park, Suwon-si (KR); Bong-Gee Song, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/732,191

(22) Filed: Apr. 2, 2007

(30) Foreign Application Priority Data
Mar. 31, 2006 (KR) 29934/2006

(51) Int. Cl. H04Q 7/20

(52) U.S. Cl. 455/436

(57) ABSTRACT

A handover method and apparatus in a communication system are provided. The method includes an MS sending to a serving BS a bandwidth allocating request message for sending a MOB_MSHO-REQ message requesting a handover; activating a timer set to a bandwidth allocation waiting time in relation to the bandwidth allocating request message; stopping the timer upon receipt of a bandwidth allocation message from the serving BS before the timer expires; and determining to perform a handover to a target BS if the MS does not receive the bandwidth allocation message from the serving BS before the timer expires.

### PRIORITY

This application claims priority under 35 U.S.C. § 119(a) to a Korean Patent Application filed in the Korean Intellectual Property Office on Mar. 31, 2006 and assigned Serial No. 2006-29934, the disclosure of which is incorporated herein by reference.

### BACKGROUND OF THE INVENTION

1. Field of the Invention

The present invention generally relates to handover in a communication system, and in particular, to a method and system for performing a handover in a Mobile Station (MS), when the MS is not allocated an uplink bandwidth in a communication system.

2. Description of the Related Art

Provisioning of services with different Quality of Service (QoS) requirements at high rates to users is an active research area in a 4^{th} Generation (4G) communication system. Studies are under way on provisioning of high-speed services in the 4G communication system by ensuring mobility and QoS to a Broadband Wireless Access (BWA) communication system such as a Wireless Local Area Network (WLAN) and a Wireless Metropolitan Area Network (WMAN). The 4G communication system uses Orthogonal Frequency Division Multiplexing (OFDM)/Orthogonal Frequency Division Multiple Access (OFDMA) for physical channels in order to support a broadband transmission network.

In a typical cellular wireless communication system, each Base Station (BS) covers its service area called cell and provides services to MSs within the cell. When an MS moves from the serving cell to a neighbor cell, it performs a handover from the serving BS to a target BS covering the neighbor cell.

FIG. 1 is a diagram illustrating a signal flow for a handover process in a conventional communication system. In FIG. 1, a handover operation among an MS 100, a serving BS 130, and a target BS 160 will be described below.

Furthermore, in FIG. 1, the MS 100 carries out a communication service with the serving BS 130 by setting up a call. The MS 100 receives reference signals, for example, pilot signals from neighbor BSs, measures the Carrier-to-Interference and Noise Ratios (CINRs) of the pilot signals, and makes a decision as to whether to change the serving BS 130, that is, whether to perform a handover.

If the MS 100 determines to change the serving BS from the current serving BS 130 to another BS, it sends a Mobile Station HandOver Request (MOB_MSHO-REQ) message to the serving BS 130 in step 111. The MOB_MSHO-REQ message is a Medium Access Control (MAC) layer message carrying neighbor BS information that the MS 100 has measured to perform a handover to another BS.

The serving BS 130 replies to the MS 100 with a Base Station HandOver Response (MOB_BSHO-RSP) message in step 113. The MOB_BSHO-RSP message is a MAC layer message including recommended BS information.

The MS 100 acquires handover information regarding neighbor BSs from the MOB_BSHO-RSP message. While the MS 100 initiates the handover, as illustrated in FIG. 1, the serving BS 130 may initiate the handover without the MS's request, for the reason of load sharing or other reasons. Hence, while not shown, the serving BS 130 may send a Base Station HandOver Request (MOB_BSHO-REQ) message to the MS 100. The MOB_BSHO-REQ message is a MAC layer message by which the serving BS 130 requests a handover to the MS 100.

Handover information sent between the MS 100 and the serving BS 130 by the MOB_MSHO-REQ message, the MOB_BSHO-RSP message, and the MOB_BSHO-REQ message contains service level prediction information, handover process optimization information, HandOver Identification (HO-ID) information, HO_authorization_policy_support information, and the like.

Upon receipt of the MOB_BSHO-RSP message, the MS 100 sends a HandOver Indication (MOB_HO-IND) message to the serving BS, notifying that it will perform a handover to the target BS 160 in step 115. Then, the MS 100 releases the call from the serving BS 130.

The MS 100 performs network re-entry to the target BS 160 as a new serving BS. The network re-entry is done for ranging, re-negotiation, re-authentication, and re-registration between the MS 100 and the target BS 160.

The target BS 160 sends a ranging information element, for example, a Fast Ranging Information Element (Fast_Ranging_IE) to the MS 100, for fast handover in step 117. As the Fast_Ranging_IE is delivered in an UpLink (UL) MAP, a Code Division Multiple Access (CDMA) code ranging procedure may not be performed.

As the target BS 160 sends the Fast_Ranging_IE to the MS 100, it allocates an UpLink BandWidth (UL BW) in which the MS 100 will send a RaNGing-REQuest (RNG-REQ) message. Then, the MS 100 sends the RNG-REQ message in the allocated UL BW to the target BS 160, for ranging in step 119.

However, since the above messages are exchanged between the MS 100 and the BSs 130 and 160 at a cell boundary with weak signals or in a handover region, the messages have a high transmission/reception failure probability. Specifically when the MS 130 fails to receive a message, for instance, the MOB_BSHO-RSP message from the serving BS 130 or is not allocated a UL BW by failing to receive the UL MAP from the target BS 160, the handover is failed. Even though the MS 100 normally receives the MOB_BSHO-RSP message, if it fails to be allocated a UL BW by which to send the MOB_HO-IND message to the serving BS 130, the handover is failed. When the MS 100 does not receive the MOB_BSHO-RSP message or is not allocated a UL BW from the serving BS, it cannot perform the handover to the target BS 160 normally.

### SUMMARY OF THE INVENTION

An aspect of exemplary embodiments of the present invention is to address at least the problems and/or disadvantages and to provide at least the advantages described below. Accordingly, one aspect of the present invention is to provide a method and apparatus for performing a handover in a communication system.

Another aspect of the present invention is to provide a method and apparatus for performing a handover in case of a failed transmission/reception of a handover message in a communication system.

A further aspect of the present invention is to provide a method and apparatus for performing a handover without a handover indication message in a communication system.

Still another aspect of the present invention is to provide a method and apparatus for performing a handover in an MS, when the MS is not allocated a UL BW in a communication system.

Yet another aspect of the present invention is to provide a method and apparatus for performing a handover to prevent a deadlock caused by an abnormal implementation of a handover process in a communication system.

According to one aspect of the present invention, there is provided a handover method of an MS in a communication system having the MS, a serving BS for providing a service to the MS, and a target BS to which the MS moves by a handover. The method includes the MS sending to the serving BS a bandwidth allocating request message for sending a MOB_MSHO-REQ message requesting a handover; activating a timer set to a bandwidth allocation waiting time in relation to the bandwidth allocating request message; stopping the timer upon receipt of a bandwidth allocation message from the serving BS before the timer expires; and the target BS determining to perform a handover if the MS does not receive the bandwidth allocation message from the serving BS before the timer expires.

According to another aspect of the present invention, there is provided a handover method of an MS in a communication system having the MS, a serving BS for providing a service to the MS, and a target BS to which the MS moves by a handover. The method includes the MS sending to the serving BS a bandwidth allocating request message for sending a MOB_HO-IND message indicating that the MS will perform a handover, if the MS determines to perform the handover; activating a timer set to a bandwidth allocation waiting time in relation to the bandwidth allocating request message; stopping the timer upon receipt of a bandwidth allocation message from the serving BS before the timer expires; and performing the handover to the target BS if the MS does not receive the bandwidth allocation message from the serving BS before the timer expires.

According to another aspect of the present invention, there is provided a handover apparatus in a communication system having an MS, a serving BS for providing a service to the MS, and a target BS to which the MS moves by a handover. The apparatus includes the MS sending to the serving BS a bandwidth allocating request message for sending a MOB_MSHO-REQ message requesting a handover, activating a timer set to a bandwidth allocation waiting time in relation to the bandwidth allocating request message, stopping the timer upon receipt of a bandwidth allocation message from the serving BS before the timer expires, and the target BS determining to perform a handover if the MS does not receive the bandwidth allocation message from the serving BS before the timer expires.

According to still another aspect of the present invention, there is provided a handover apparatus in a communication system having an MS, a serving BS for providing a service to the MS, and a target BS to which the MS moves by a handover. The apparatus includes the MS sending to the serving BS a bandwidth allocating request message for sending a MOB_HO-IND message indicating that the MS will perform a handover, if the MS determines to perform the handover, activating a timer set to a bandwidth allocation waiting time in relation to the bandwidth allocating request message, stopping the timer upon receipt of a bandwidth allocation message from the serving BS before the timer expires, and performing the handover to the target BS if the MS does not receive the bandwidth allocation message from the serving BS until the timer expires.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a flow diagram illustrating a signal flow for a handover process in a conventional communication system;

FIG. 2 is a flow diagram illustrating a signal flow between an MS and a serving BS in a handover process in a communication system according to an exemplary embodiment of the present invention; and

FIGS. 3A, 3B and 3C are flowcharts illustrating an MS operation in the handover process in the communication system according to an exemplary embodiment of the present invention.

### DETAILED DESCRIPTION OF PREFERRED EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

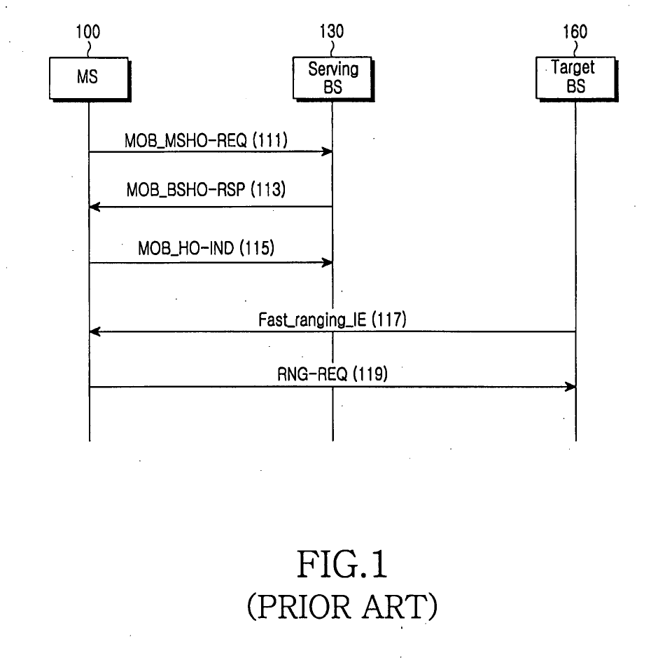

Exemplary embodiments of the present invention provide a handover method for an MS when the MS is not allocated an UL BW during a handover process between a transmitter and a receiver, i.e. between a BS and the MS in a wireless communication system. A conventional handover process is described with reference to FIG. 1.

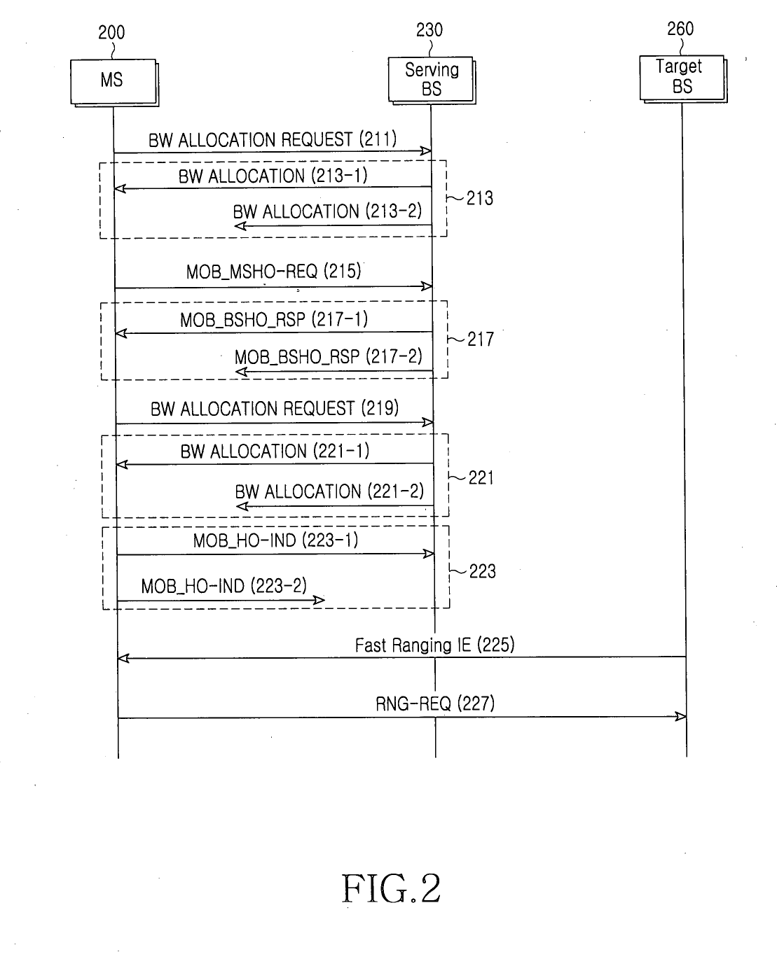

FIG. 2 is a flow diagram illustrating a signal flow for an MS operation in a handover process in a communication system according to an exemplary embodiment of the present invention.

In FIG. 2, in a handover process among an MS 200, a serving BS 230, and a target BS 260, the MS 200 first performs a service with the serving BS 230 by setting up a call. The MS 200 receives reference signals, for example, pilot signals from neighbor BSs, measures the CINRs of the pilot signals, and makes a decision as to whether to change the serving BS 230, that is, whether to perform a handover.

If the MS 200 determines to change the serving BS from the current serving BS 230 to another BS, the MS 200 sends to the serving BS 230 a BW allocation request message requesting a UL BW for sending a MOB_MSHO-REQ message in step 211.

In step 213, the serving BS 230 replies to the MS 200 with a BW allocation message of allocating BW. This step is branched into step 213-1 in case of successful reception at the MS 200 and step 213-2 in case of a failed reception at the MS 200.

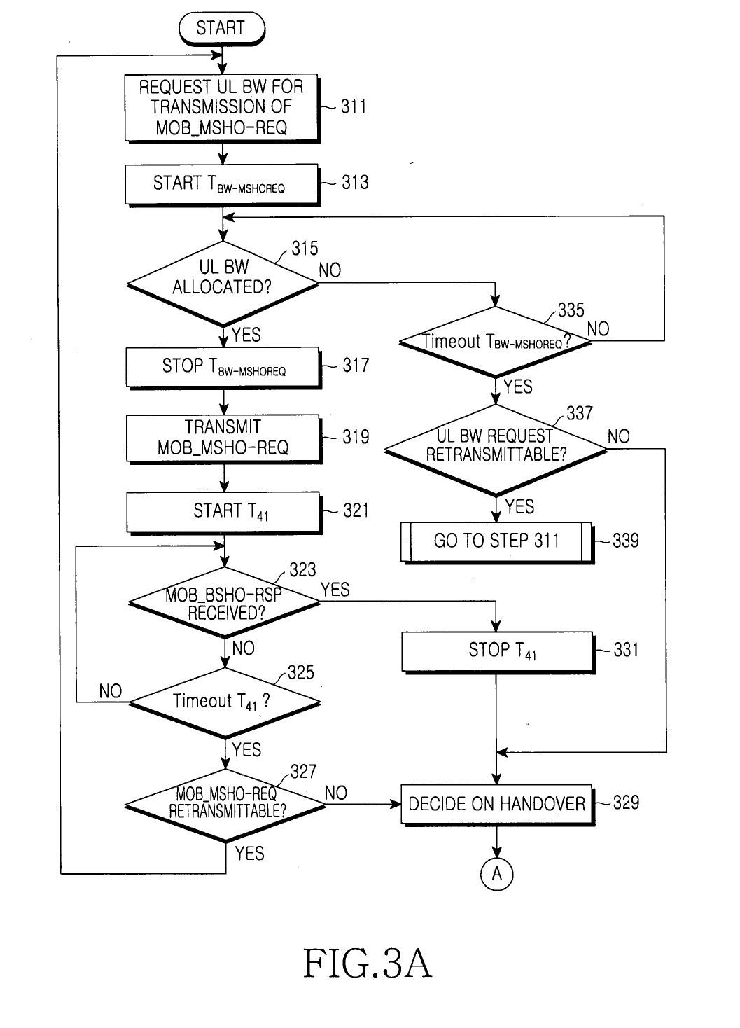

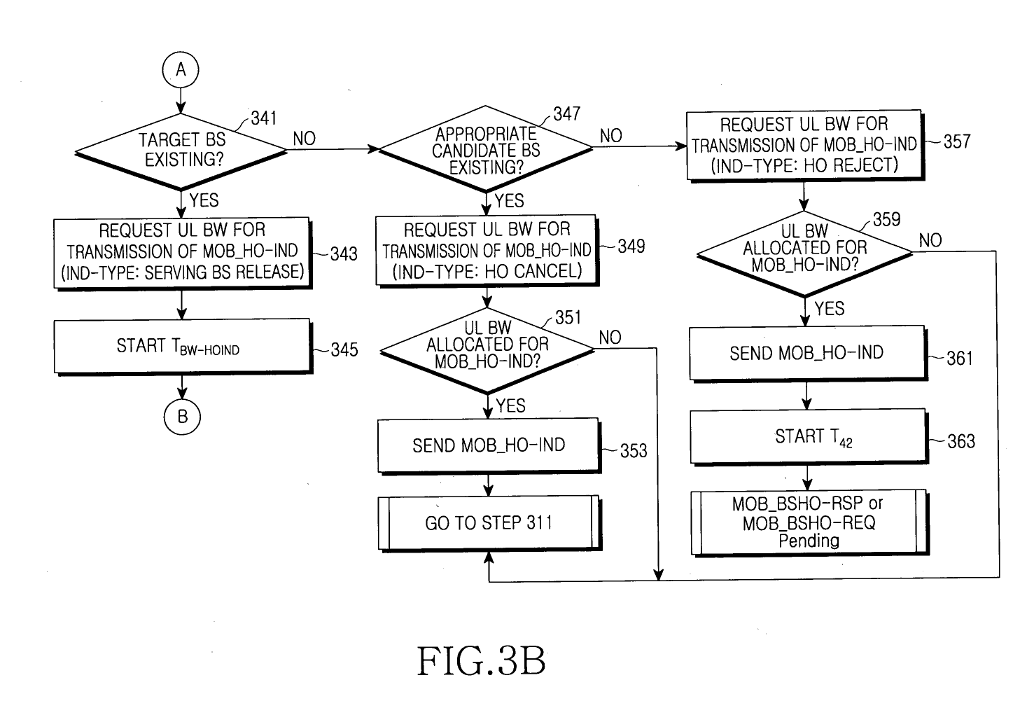

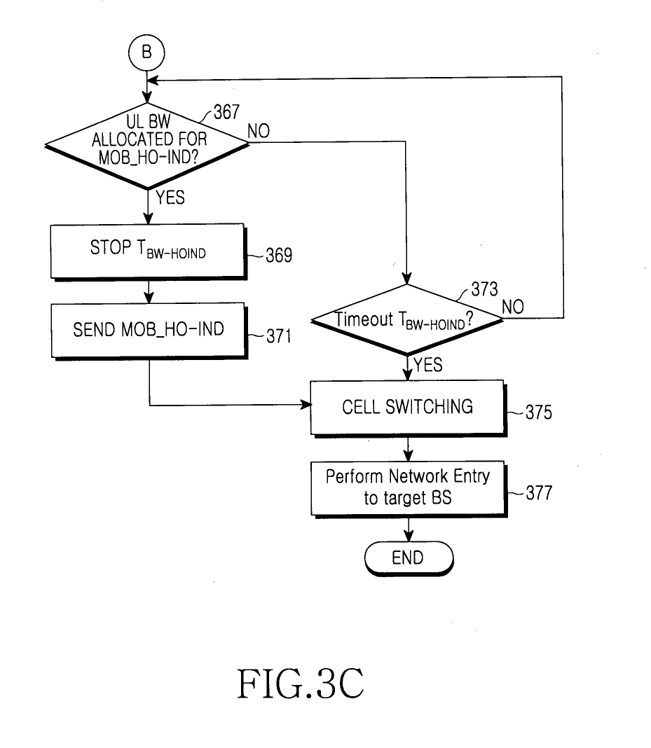

If the MS 200 receives the BW allocation message successfully in step 213-1, a handover is performed in a conventional method. Conversely, if the MS 200 fails to receive the BW allocation message in step 213-2, the MS 200 performs a handover operation using a timer set to a predetermined time value or based on a predetermined number of transmissions, as described below with reference to FIGS. 3A, 3B and 3C.

In case of the successful reception of the BW allocation message in step 213-1, the MS 200 sends the MOB_MSHO-REQ message to the serving BS 230 in step 215. The MOB_MSHO-REQ message is a MAC layer message carrying neighbor BS information that the MS 100 has calculated to perform a handover to another BS.

The serving BS 230 replies to the MS 100 with a MOB_BSHO-RSP message in step 217. The MOB_BSHO-RSP message is a MAC layer message including recommended BS information.

The MS 200 may receive the MOB_BSHO-SRP message successfully in step 217-1 and may fail to receive the MOB_BSHO-SRP message in step 217-2. The MS 200 performs a normal handover operation in the former case and the handover operation using a timer or a predetermined number of transmissions as described later in FIGS. 3A, 3B and 3C.

If the MS 200 receives the MOB_BSHO-RSP message successfully in step 217-1, the MS 200 acquires handover information regarding neighbor BSs from the MOB_BSHO-RSP message.

The MS 200 receives handover information through the MOB_BSHO-RSP message from the serving BS 230. The handover information contains service level prediction information, handover process optimization information, HO-ID information, HO_authorization_policy_support information, and the like.

Upon receipt of the MOB_BSHO-RSP message, the MS 200 sends a MOB_HO-IND message to the serving BS, notifying that the MS 200 will perform a handover to the target BS 160 in step 223. Then, the MS 200 releases the call from the serving BS 230.

For the transmission of the MOB_HO-IND message, the MS 200 sends a BW allocation request message to the serving BS 230 in step 219. In step 221, the serving BS 230 replies to the MS 200 with a BW allocation message. This step is branched into step 221-1 in case of successful a reception at the MS 200 and step 221-2 in case of a failed reception at the MS 200.

If the MS 200 receives the BW allocation message successfully in step 221-1, the handover is performed normally as done conventionally. On the other hand, if the MS 200 fails to receive the BW allocation message in step 221-2, the MS 200 performs the handover operation using a timer or based on a predetermined number of transmissions as shown in FIGS. 3A, 3B and 3C.

Then, the MS 200 performs network re-entry to the target BS 260 as a new serving BS. The network re-entry is done for ranging, re-negotiation, re-authentication, and re-registration between the MS 200 and the target BS 260.

The target BS 260 sends a ranging information element, for example, Fast_Ranging_IE to the MS 200, for fast handover in step 225. As the Fast_Ranging_IE is delivered in a UL MAP, a CDMA code ranging procedure may not be performed.

As the target BS 260 sends the Fast_Ranging_IE to the MS 200, the target BS 260 allocates an UL BW in which the MS 200 will send an RNG-REQ message. Then, the MS 200 sends the RNG-REQ message in the allocated UL BW to the target BS 260, for ranging in step 227.

Below is a description of a process of the MS in a broadband wireless communication system according to an exemplary embodiment of the present invention.

FIGS. 3A, 3B and 3C are flowcharts illustrating an MS operation in the handover process in the communication system according to an exemplary embodiment of the present invention.

In FIG. 3A, the MS sends to the serving BS a BW allocation request message requesting a UL BW in which the MS will send a MOB_MSHO-REQ message in step 311.

The MS activates a timer T_{BW-MSHOREQ} set to a predetermined time value in step 313. The predetermined time value is a time period for which the MS waits after sending the BW allocation message.

In step 315, the MS monitors allocation of an UL BW for sending the MOB_MSHO-REQ message. If the UL BW has been allocated from the serving BS, the MS proceeds to step 317 and otherwise, the MS jumps to step 335.

The MS stops the timer T_{BW-MSHOREQ} because of the successful allocation of the UL BW in step 317. Then the handover process starts with the MOB-MSHO-REQ message.

The MS sends the MOB_MSHO-REQ message in the allocated UL BW to the serving BS in step 319 and activates a timer T₄₁ in step 321. In step 323, the MS monitors reception of a MOB-BSHO-RSP message from the serving BS. If the MS fails to receive the MOB-BSHO-RSP message, the MS goes to step 325.

Upon receipt of the MOB-BSHO-RSP message, the MS stops the timer T₄₁ in step 331 and goes to step 329.

In step 325, the MS monitors timeout of the timer T₄₁. Upon timeout, the MS goes to step 327. If the timer T₄₁ is still running, the MS returns to step 323.

In step 327, the MS compares the number of retransmissions of the MOB_MSHO-REQ message with a predetermined retransmission number. If the retransmission number is less than the predetermined retransmission number, the MS returns to step 311. If, however, the retransmission number is greater than or equal to the predetermined retransmission number, the MS proceeds to step 329.

In step 335, the MS monitors timeout of the timer T_{BW-MSHOREQ}. Upon timeout of the timer T_{BW-MSHOREQ}, the MS goes to step 337. If the timer T_{BW-MSHOREQ} is still running, the MS returns to step 315.

In step 337, the MS compares the number of retransmissions of the BW allocation request message for the MOB-MSHO-REQ message with a predetermined retransmission number. If the retransmission number is less than the predetermined retransmission number, the MS returns to step 311. If the retransmission number is greater than or equal to the predetermined retransmission number, the MS proceeds to step 329.

The MS decides on a handover in step 329 and then proceeds to step 341.

In FIG. 3B, the MS searches for a target BS for the handover in step 341. If the target BS is detected, the MS goes to step 343. In the absence of the target BS, the MS goes to step 347.

The MS sends to the serving BS a BW request message requesting a UL BW by which the MS will send a MOB_HO-IND message with an IND-TYPE set to Serving BS Release in step 343 and goes to step 345.

In step 345, the MS activates a timer T_{BW-HOIND} set to a predetermined time value. Then the MS proceeds to step 367. The predetermined time value is a time period for which the MS waits after sending the BW allocation message.

In step 347, the MS determines whether any candidate BS for the handover exists. In the presence of any candidate BS, the MS goes to step 349. In the absence of any candidate BS, the MS goes to step 357.

The MS cancels the handover and sends to the serving BS a BW allocation request message requesting a UL BW in which the MS will send a MOB_HO-IND message with the IND-TYPE set to HO-Cancel to maintain communications with the serving BS in step 349.

Then the MS monitor allocation of the UL BW for the MOB_HO-IND message in step 351. Upon the UL BW allocation, the MS goes to step 353. If the UL BW has not been allocated, the MS returns to step 311. The MS sends the MOB_HO-IND message to the serving BS in step 353 and returns to step 311.

In step 357, the MS sends to the serving BS a BW allocation request message requesting a UL BW in which the MS will send a MOB_HO-IND message with IND-TYPE set to HO-Reject to obtain information about a new candidate BS for the handover in step 357.

Then the MS monitor allocation of the UL BW for the MOB_HO-IND message in step 359. Upon the UL BW allocation, the MS goes to step 361. If the UL BW has not been allocated, the MS returns to step 311.

The MS sends the MOB_HO-IND message to the serving BS in step 361 and activates a timer T₄₂ in step 363. Then the MS awaits reception of a MOB_BSHO-RSP message or a MOB_BSHO-REQ message in step 365.

In FIG. 3C, the MS monitors allocation of the UL BW for sending the MOB_HO-IND message in step 367.

Upon the UL BW allocation, the MS goes to step 369. If the UL BW has not been allocated from the serving BS, the MS goes to step 373.

The MS stops the timer T_{BW-HOIND} in step 369 and sends the MOB_HO-IND message to the serving BS in step 371. Then the MS goes to step 375.

In step 373, the MS monitors timeout of the timer T_{BW-HOIND}. Upon timeout of the timer T_{BW-HOIND}, the MS goes to step 375. If the timer T_{BW-HOIND} is still running, the MS returns to step 367.

In step 375, the MS decides on cell switching to the target BS, that is, determines to change the serving BS. Thus, the MS changes the serving BS from the current serving BS to the target BS by network entry to the target BS in step 377.

The time values to which the timer is set and the predetermined transmission numbers are variable depending on system situation or system characteristics. Hence, a detailed description of the time values and the transmission numbers is not provided herein.

The present invention is characterized in that it flexibly copes with obstacles to reliable implementation of the handover process by use of a timer set to a time value for which the MS waits for BW allocation to send the MOB_MSHO-REQ message or the MOB_HO-IND message. The present invention achieves technical advantages in cases where the serving BS fails to receive the MOB_HO-IND message, the target BS uses a serving BS ID set in an RNG-REQ message and can receive information about the serving BS over a backbone network.

As described above, during a handover process between an MS and a BS in a communication system, if a message is lost or a UL BW for message transmission is not allocated to the MS, the MS performs the handover process using a BW allocation timer. Therefore, the handover is carried out flexibly and a service is seamlessly provided. Furthermore, the handover can be provided without transmission/reception of handover-associated messages, especially a handover indication message.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A handover method of a Mobile Station (MS) in a communication system having the MS, a serving Base Station (BS) for providing a service to the MS, and a target BS to which the MS moves by a handover, the method comprising:
sending to the serving BS a bandwidth allocating request message for sending a Mobile Station HandOver Request (MOB_MSHO-REQ) message requesting a handover;
activating a timer set to a bandwidth allocation waiting time in relation to the bandwidth allocating request message;
stopping the timer upon receipt of a bandwidth allocation message from the serving BS before the timer expires; and
determining to perform a handover to the target BS if the MS does not receive the bandwidth allocation message from the serving BS before the timer expires.

2. The handover method of claim 1, wherein the bandwidth is an uplink bandwidth.

3. The handover method of claim 1, further comprising retransmitting the bandwidth allocation request message, if the MS does not receive the bandwidth allocation request message from the serving BS before the timer expires.

4. The handover method of claim 3, further comprising:
comparing the number of retransmissions of the bandwidth allocation request message with a retransmission number, when the bandwidth allocation request message is retransmitted; and
determining to perform a handover to the target BS, if the number of retransmissions of the bandwidth allocation request message is greater than equal to the retransmission number.

5. The handover method of claim 1, further comprising:
sending to the serving BS a bandwidth allocation request message for sending a Mobile Station Handover Indication (MOB_HO-IND) message indicating that the MS will perform the handover, if the MS determines to perform a handover to the target BS.

6. A handover method of a Mobile Station (MS) in a communication system having the MS, a serving Base Station (BS) for providing a service to the MS, and a target BS to which the MS moves by a handover, the method comprising:
sending to the serving BS a bandwidth allocating request message for sending a Mobile Station HandOver Indication (MOB_HO-IND) message indicating that the MS will perform a handover, if the MS determines to handover;
activating a timer set to a bandwidth allocation waiting time in relation to the bandwidth allocating request message;
stopping the timer upon receipt of a bandwidth allocation message from the serving BS before the timer expires; and
performing the handover to the target BS if the MS does not receive the bandwidth allocation message from the serving BS before the timer expires.

7. The handover method of claim 6, wherein the bandwidth is an uplink bandwidth.

8. The handover method of claim 6, further comprising retransmitting the bandwidth allocation request message, if the MS does not receive the bandwidth allocation request message from the serving BS before the timer expires.

9. The handover method of claim 8, further comprising:
comparing the number of retransmissions of the bandwidth allocation request message with a retransmission number, when the bandwidth allocation request message is retransmitted; and
determining to perform a handover to the target BS, if the number of retransmissions of the bandwidth allocation request message is greater than or equal to the retransmission number.

10. The handover method of claim 6, further comprising performing network entry to the target BS to perform the handover.

11. A handover apparatus in a communication system having a Mobile Station (MS), a serving Base Station (BS) for providing a service to the MS, and a target BS to which the MS moves by a handover, comprising:
the MS for sending to the serving BS a bandwidth allocating request message for sending a Mobile Station HandOver Request (MOB_MSHO-REQ) message requesting a handover, activating a timer set to a bandwidth allocation waiting time in relation to the bandwidth allocating request message, stopping the timer upon receipt of a bandwidth allocation message from the serving BS before the timer expires, and determining to perform a handover to the target BS if the MS does not receive the bandwidth allocation message from the serving BS before the timer expires.

12. The handover apparatus of claim 11, wherein the bandwidth allocation waiting time is a time period for which the MS awaits reception of a bandwidth allocation message from the serving BS after sending the bandwidth allocation request message.

13. The handover apparatus of claim 11, wherein the bandwidth is an uplink bandwidth.

14. The handover apparatus of claim 11, wherein the MS retransmits the bandwidth allocation request message, if the MS does not receive the bandwidth allocation request message from the serving BS before the timer expires.

15. The handover apparatus of claim 14, wherein when the bandwidth allocation request message is retransmitted, the MS compares the number of retransmissions of the bandwidth allocation request message with a retransmission number, and determines to perform a handover to the target BS, if the number of retransmissions of the bandwidth allocation request message is greater than or equal to the retransmission number.

16. The handover apparatus of claim 11, wherein if the MS determines to perform a handover to the target BS, the MS sends to the serving BS a bandwidth allocation request message for sending a Mobile Station Handover Indication (MOB_HO-IND) message indicating that the MS will perform the handover.

17. A handover apparatus in a communication system having a Mobile Station (MS), a serving Base Station (BS) for providing a service to the MS, and a target BS to which the MS moves by a handover, comprising:
the MS for sending to the serving BS a bandwidth allocating request message for sending a Mobile Station HandOver Indication (MOB_HO-IND) message indicating that the MS will perform a handover, if the MS determines to perform handover, activating a timer set to a bandwidth allocation waiting time in relation to the bandwidth allocating request message, stopping the timer upon receipt of a bandwidth allocation message from the serving BS before the timer expires, and performing the handover to the target BS if the MS does not receive the bandwidth allocation message from the serving BS before the timer expires.

18. The handover apparatus of claim 17, wherein the bandwidth allocation waiting time is a time period for which the MS awaits reception of a bandwidth allocation message from the serving BS after sending the bandwidth allocation request message.

19. The handover apparatus of claim 17, wherein the bandwidth is an uplink bandwidth.

20. The handover apparatus of claim 17, wherein the MS retransmits the bandwidth allocation request message, if the MS does not receive the bandwidth allocation request message from the serving BS before the timer expires.

21. The handover apparatus of claim 20, wherein when the bandwidth allocation request message is retransmitted, the MS compares the number of retransmissions of the bandwidth allocation request message with a retransmission number, and determines to perform a handover to the target BS, if the number of retransmissions of the bandwidth allocation request message is greater than a equal to the retransmission number.

22. The handover apparatus of claim 17, wherein the MS performs network entry to the target BS to perform the handover.
